(19) United States
(12) Patent Application Publication
(10) Pub. No.: US 2025/0111251 A1
(43) Pub. Date: Apr. 3, 2025

(54) METHODS AND SYSTEMS FOR PROACTIVE PROBLEM TROUBLESHOOTING AND RESOLUTION IN A CLOUD INFRASTRUCTURE

(71) Applicant: VMware, Inc., Palo Alto, CA (US)

(72) Inventors: Arnak Poghosyan, Yerevan (AM); Ashot Nshan Harutyunyan, Yerevan (AM); Eduard Amirkhanyan, Yerevan (AM); Tigran Mkrtchyan, Yerevan (AM); Avetik Havhannisyan, Yerevan (AM); Vahe Minasyan, Palo Alto, CA (US); Hakob Arakelyan, Yerevan (AM)

(73) Assignee: VMware, Inc., Palo Alto, CA (US)

(21) Appl. No.: 18/376,378

(22) Filed: Oct. 3, 2023

(51) Int. Cl. G06N 5/025

(52) U.S. Cl. CPC G06N 5/025

(57) ABSTRACT

Automated computer-implemented methods and systems for troubleshooting and resolving problems with objects of a cloud infrastructure are described herein. In response to detecting abnormal behavior of an object running in the cloud infrastructure based on a key performance indicator (“KPI”) of the object, a graphical user interface (“GUI”) is displayed to enable a user to select KPIs of components of the object. For each of the components, a separate rule learning engine is deployed to generate rules for detecting a problem with the component based on the KPI of the object and the KPIs of the component. The rules are subsequently used to detect a runtime problem with the object and display in the GUI remedial measures for resolving the problem. Remedial measures are automatically executed to resolve the problem with the object via the GUI.

### TECHNICAL FIELD

This disclosure is directed to detection and resolution of problems in a cloud infrastructure.

### BACKGROUND

Electronic computing has evolved from primitive, vacuum-tube-based computer systems, initially developed during the 1940s, to modern electronic computing systems with large numbers of multi-processor computer systems, such as server computers and workstations, are networked together with large-capacity data-storage devices to produce geographically distributed computing systems that provide enormous computational bandwidths and data-storage capacities. These large, distributed computing systems include data centers and are made possible by advancements in virtualization, computer networking, distributed operating systems and applications, data-storage appliances, computer hardware, and software technologies. The data center hardware, virtualization, abstracted resources, data storage, and network resources combined form a cloud infrastructure that is used by organizations, such as governments and ecommerce businesses, to run applications that provide business services, web services, streaming services, and other cloud services to millions of users each day.

In recent years, cloud management tools have been developed to monitor performance of applications and generate alerts when performance problems with applications arise. Despite extensive efforts and advancements in cloud management tools, performance problem detection and alert troubleshooting in a cloud infrastructure remains a problem for systems administrator, application owners, and product engineers. The typical steps that systems administrators and application owners go through to troubleshoot a performance problem are as follows: 1) A cloud management tool generates an alert that systems administrator, application owners, and product engineers cannot understand or use to diagnose the underlying problem. 2) The alert is escalated to a site reliability engineering (“SRE”) team or global support services (“GSS”) team to try and resolve the problem. 3) If the problem is complicated and cannot be resolved by an SRE/GSS team, an application development (“AD”) team is engaged to manually troubleshoot the problem. 4) A typical AD team can spend hours, days and in some cases weeks to determine a root cause of problem. 5) Once the cause of the problem is determined, appropriate remedial measures are executed to correct the problem. Overall, this five step process is time consuming, error prone at different stages of each step, and extremely expensive to the application owner in terms of lost revenue due to down time, damage to reputation and brand name, and cost of employing various teams of engineers to detect and correct the problem. Moreover, the knowledge gained by teams of engineers during this process is typically not shared between individuals and recorded in a manner that can be used by subsequent teams of engineers to diagnose a similar performance problem in the future. AD teams currently have no tools for automatic knowledge sharing and root cause analysis of performance problems in a cloud infrastructure. Cloud infrastructure administrators and application owners seek automated computer implemented methods and systems for troubleshooting and resolving performance problems in a cloud infrastructure.

### SUMMARY

Automated computer-implemented methods and systems for troubleshooting and resolving problems with objects of a cloud infrastructure are described herein. In response to detecting abnormal behavior of an object running in the cloud infrastructure based on a key performance indicator (“KPI”) of the object, a graphical user interface (“GUI”) is displayed to enable a user to select KPIs of components of the object. For each of the components, a separate rule learning engine is deployed to generate rules for detecting a problem with the component based on the KPI of the object and the KPIs of the component. The rules are subsequently used to detect a runtime problem with the object and display in the QUI remedial measures for resolving the problem. Remedial measures are automatically executed to resolve the problem with the object via the GUI.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machines (“VMs”) and VM execution environments.

FIG. 6 shows an example of an open virtualization format package.

FIG. 7 shows examples of virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a cloud infrastructure.

FIG. 14 shows a plot of an example metric.

FIG. 15 shows an example of a cloud proxy located between a cluster of VMs and a cloud environment.

FIG. 16 shows an example graphical user interface (“GUI”) that enables a user to view key performance indicators (“KPIs”) of the cloud proxy in FIG. 15.

FIG. 17 shows an example of time synchronizing metric values of a KPI over a user selected time interval.

FIG. 18 shows an example of how time synchronization reduces the number of metric values of a KPI.

FIG. 19 shows an example of forming class labeled tuples of an object KPI.

FIG. 20 shows an example rule learning engine used to generate rules for detecting a performance problem with an object executing in a cloud infrastructure.

FIG. 21 shows an example GUI for validating rules for detecting problems with a cloud proxy executing in a cloud infrastructure.

FIG. 22 is a flow diagram of a method for proactive troubleshooting and correcting of a problem with an object in a cloud infrastructure.

### DETAILED DESCRIPTION

This disclosure presents automated computer-implemented methods and systems for troubleshooting and resolving performance problems in a cloud infrastructure. Computer hardware, complex computational systems, and virtualization are described in the first subsection. Computer-implemented methods and systems for automated computer implemented facilitations of troubleshooting and resolving performance problems in a cloud infrastructure are described below in the second subsection.

### Computer Hardware, Complex Computational Systems, and Virtualization

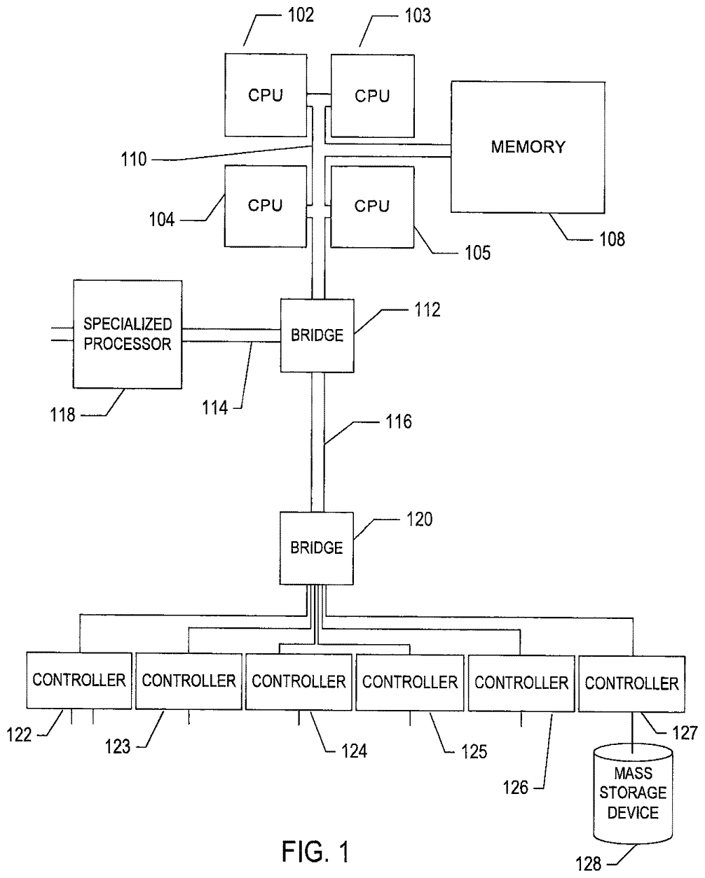

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

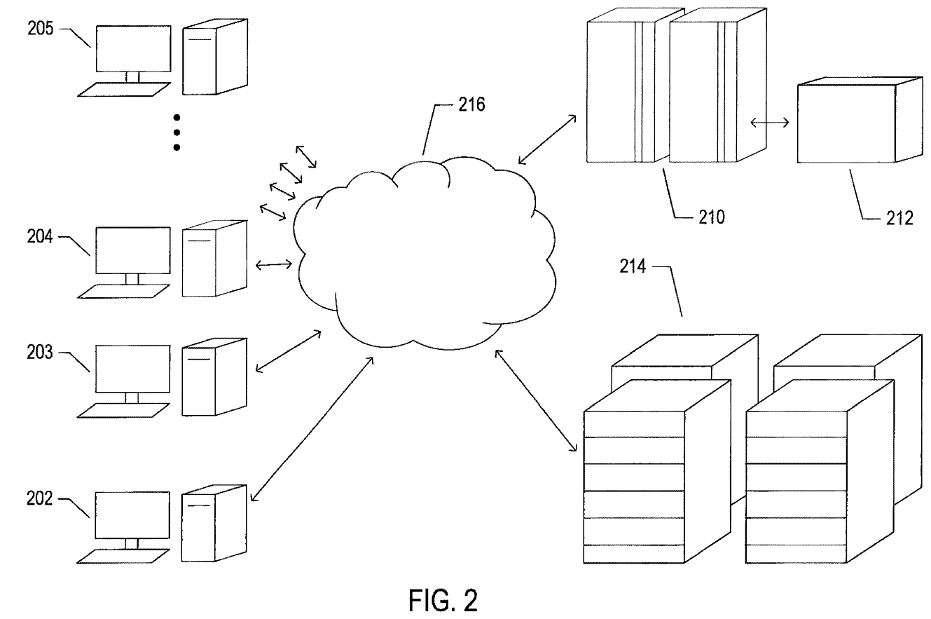

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

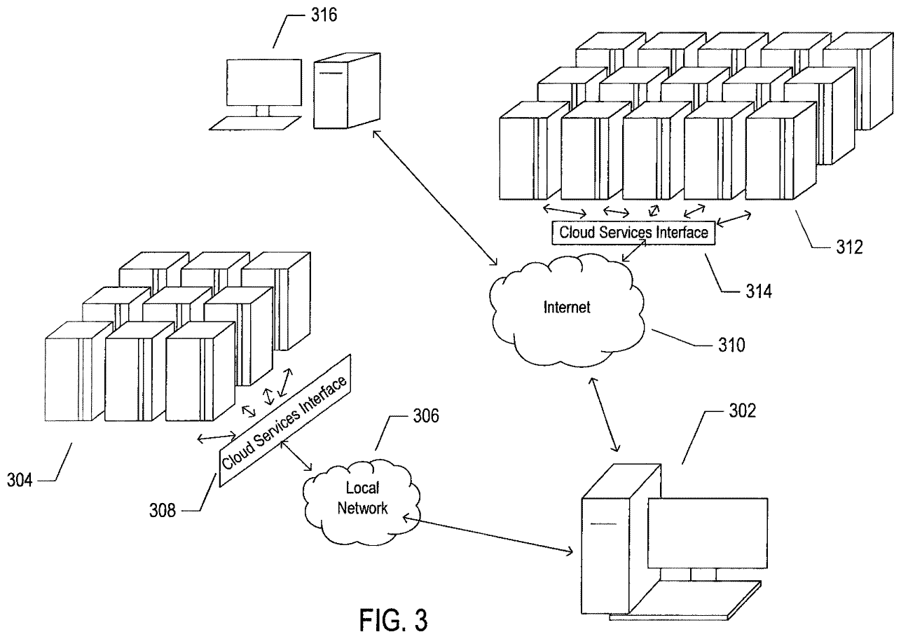

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase. manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

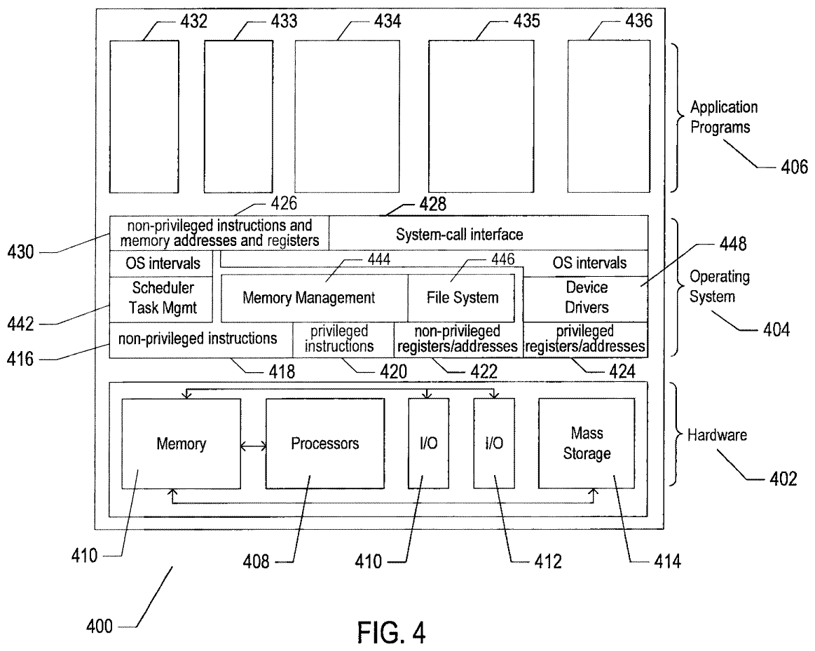

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers. and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

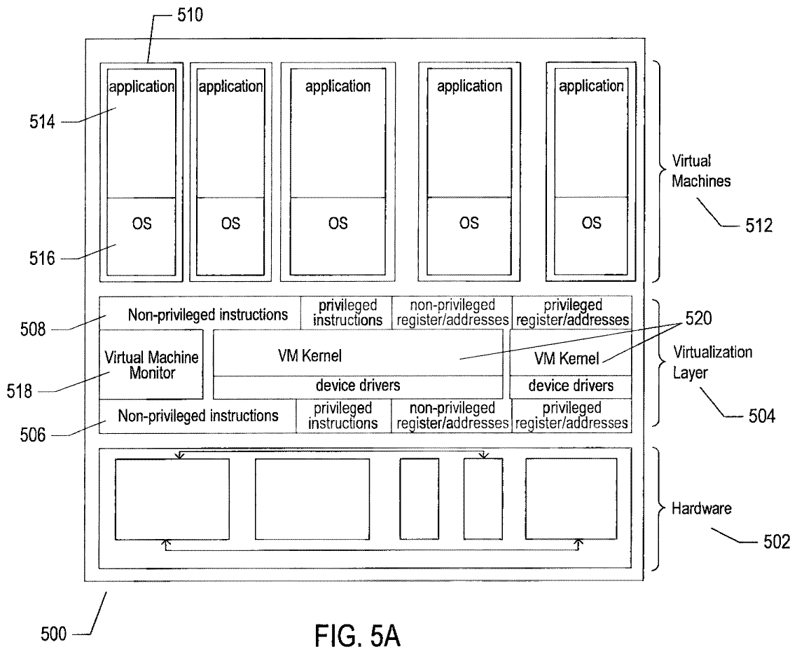

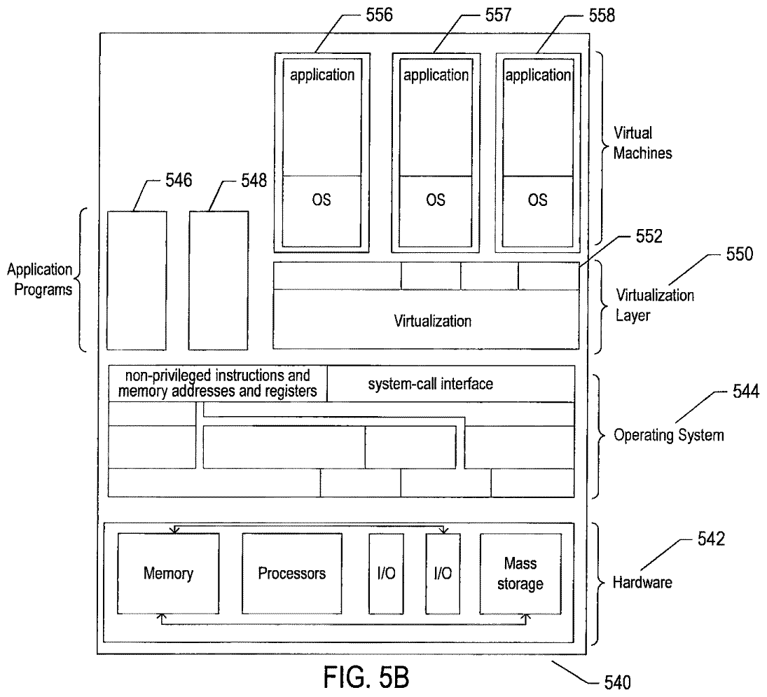

For all of these reasons, a higher level of abstraction, referred to as the “virtual machine.” (“VM”) has been developed and evolved to further abstract computer hardware in order to address many difficulties and challenges associated with traditional computing systems, including the compatibility issues discussed above. Figures SA-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

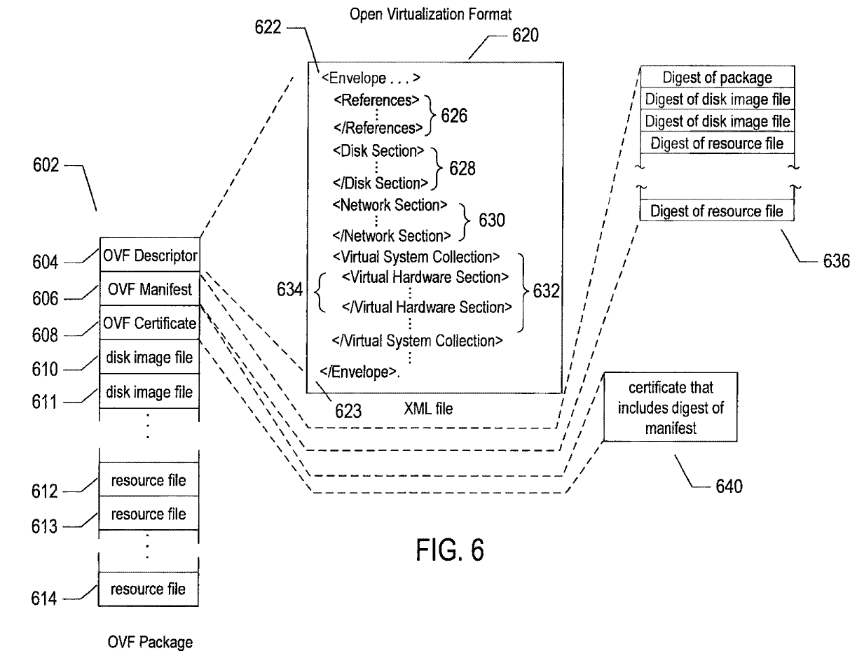

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

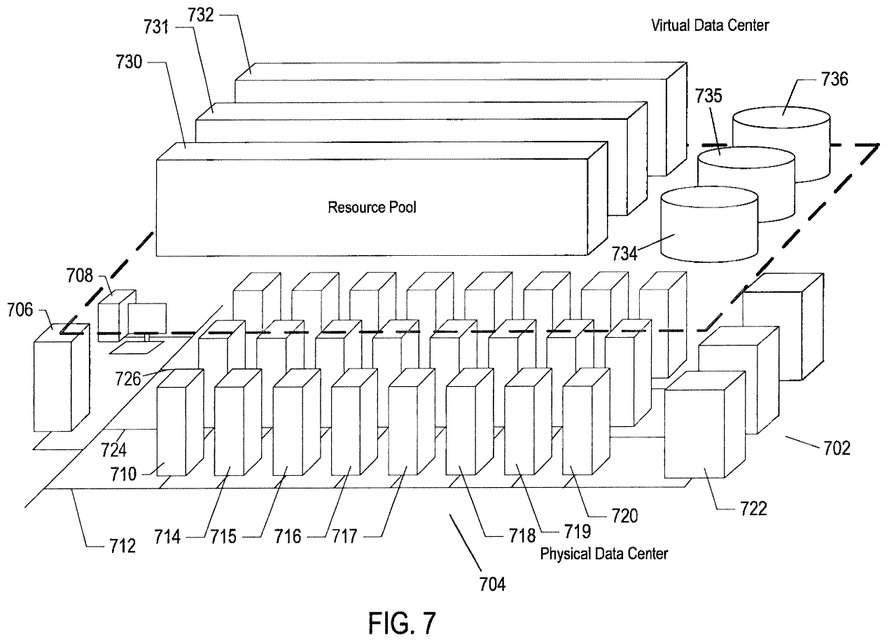

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, include a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

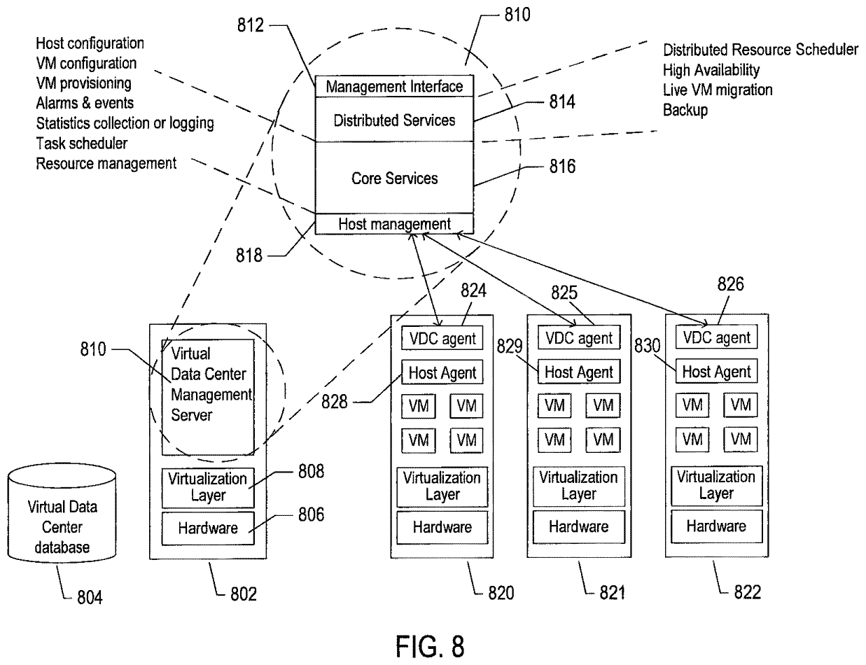

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

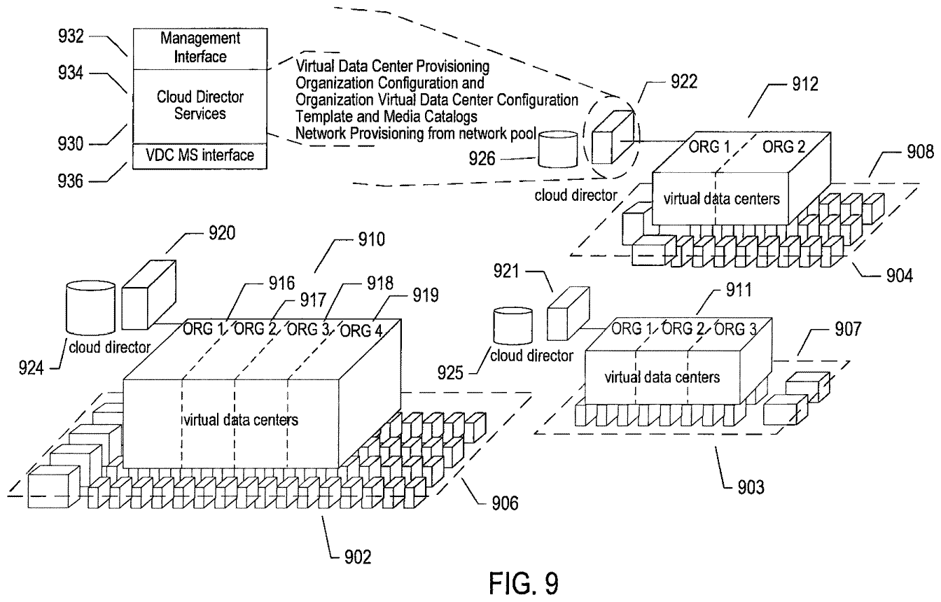

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi . . . tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

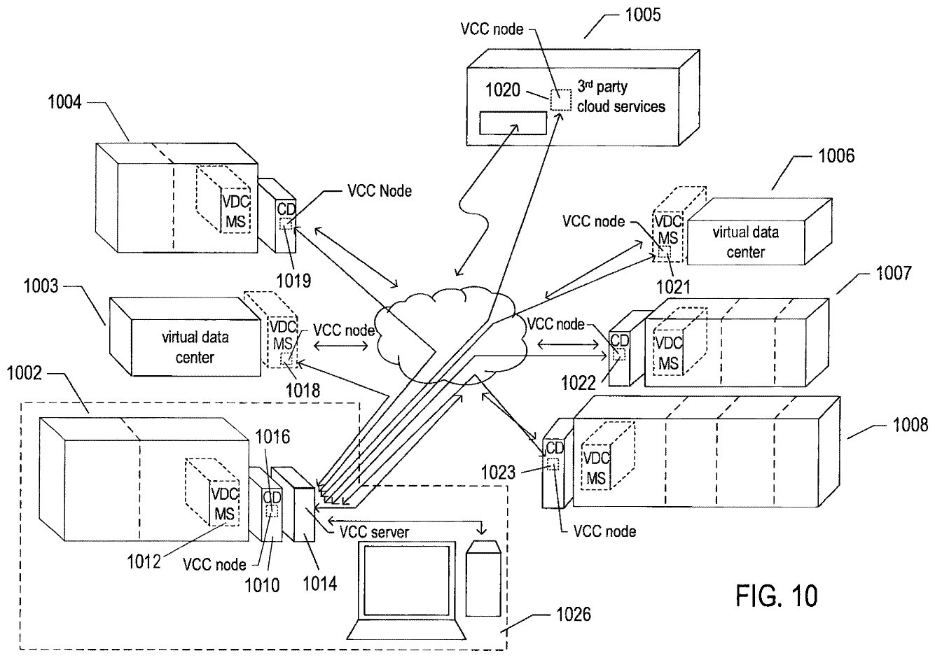

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general. the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous, distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. A container is an abstraction at the application layer that packages code and dependencies together. Multiple containers can run on the same computer system and share the operating system kernel, each container running as an isolated process in the user space. One or more containers are run in pods. For example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. The containers are isolated from one another and bundle their own software, libraries, and configuration files within in the pods. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

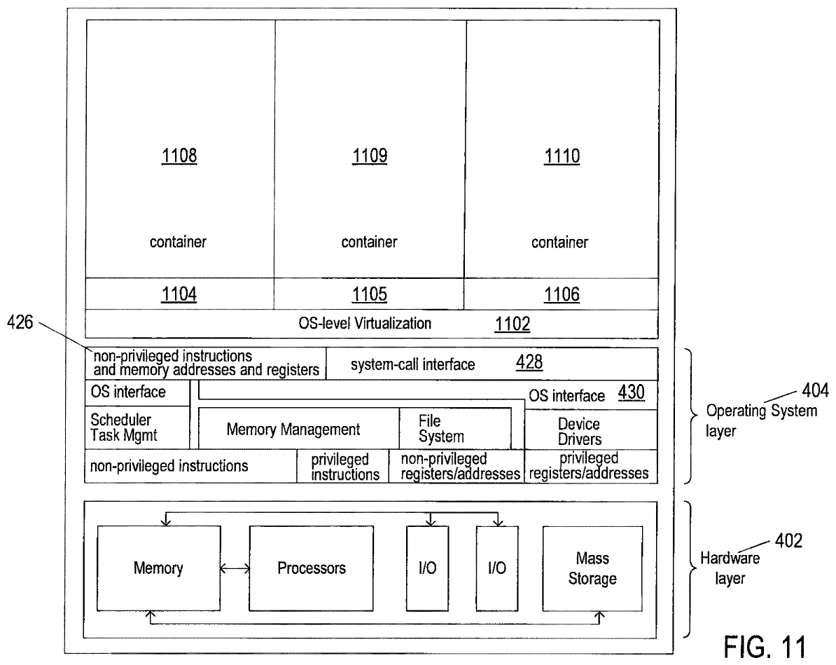

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

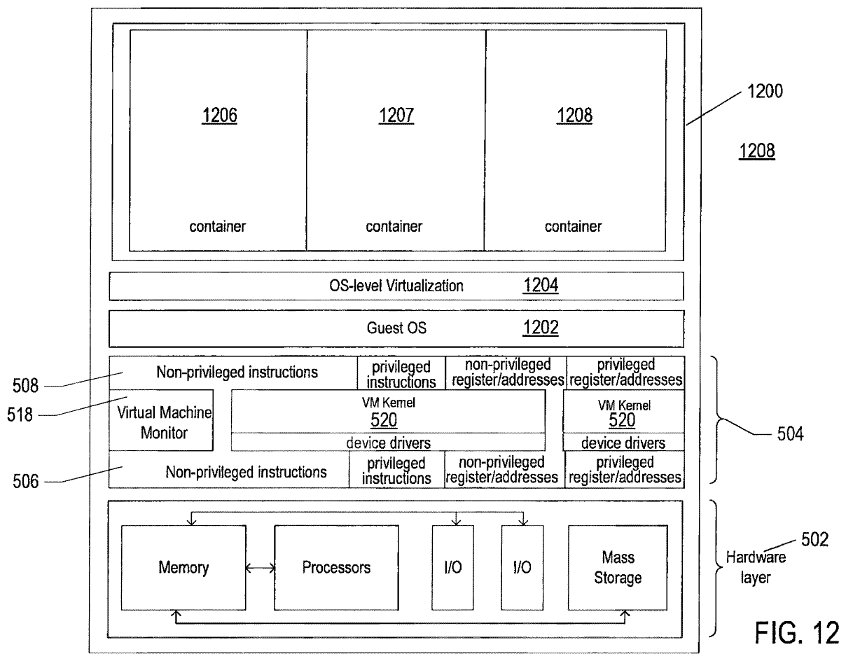

FIG. 12 shows an approach to implementing the containers in a VM. FIG. 12 shows a host computer similar to that shown in FIG. 5A, discussed above. The host computer includes a hardware layer 502 and a virtualization layer 504 that provides a virtual hardware interface 508 to a guest operating system 1202. Unlike in FIG. 5A, the guest operating system interfaces to an OSL-virtualization layer 1204 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at runtime between containers. The traditional virtualization layer provides for flexible and scaling over large numbers of hosts within large, distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Automated Computer Implemented Methods and Systems for Troubleshooting and Resolving Performance Problems in a Cloud Infrastructure

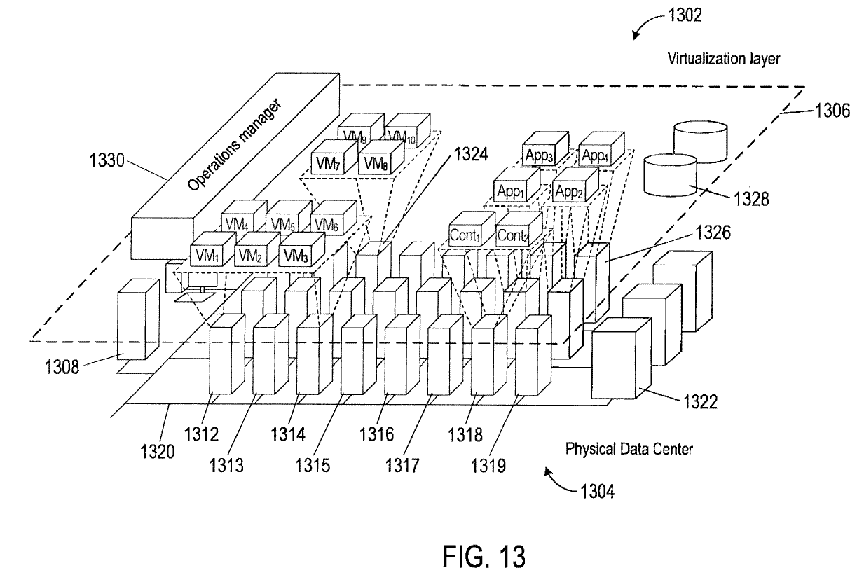

FIG. 13 shows an example of a cloud infrastructure composed of a virtualization layer 1302 located above a physical data center 1304. For the sake of illustration, the virtualization layer 1302 is separated from the data center 1304 by a virtual-interface plane: 1306. The data center 1304 is an example of a distributed computing system. The data center 1304 comprises physical objects, including an administration computer system 1308, any of various computers, such as PC 1310, on which a virtual data center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers are networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects executing in the virtualization layer 1302.

The virtualization layer 1302 includes virtual objects, such as VMs, applications, and containers, hosted by the server computers in the physical data center 1304. The virtual-interface plane 1306 abstracts the resources of the physical data center 1304 to one or more virtual objects and one or more virtual data stores, such as virtual data store 1328. The virtualization layer 1302 may also include a virtual network (not illustrated) of virtual switches, routers, load balancers, and NICs formed from the physical switches, routers, and NICs of the physical data center 1304. Certain server computers host VMs and containers as described above. For example, server computer 1318 hosts two containers identified as Cont; and Conte; cluster of server computers 1312-1314 host six VMs identified as VM₁, VM₂, VM₃, VM₄, VM₅, and VM₆; server computer 1324 hosts four VMs identified as VM₇, VM₈, VM₉, VM₁₀. Other server computers may host standalone applications as described above with reference to FIG. 4. For example, server computer 1326 hosts applications App₃ and App₄.

For the sake of illustration, the data center 1304 and virtualization layer 1302 are shown with a small number of objects. In practice, a typical data center runs thousands of server computers that are used to run thousands of VMs and containers. Different data centers may include many different types of computers, networks, data-storage systems, and devices connected according to many different types of connection topologies described below.

Computer-implemented methods described herein are performed by an operations manager 1330 that is executed on the administration computer system 1308. The computer-implemented methods and systems are a solution to the issue of employing AD teams to troubleshoot and resolve problems in a cloud infrastructure. The methods and systems execute an analytics system with explainable artificial intelligence methods that build and maintain machine learning models based on streams of metric data collected by the operations manager 1330. The machine learning models are able to learn explainable and causative patterns in the metric data for generating alerts in response to various problem types recorded in metric data.

Each stream of metric data received by the operations manager 1330 is time-series data generated by an event source, such as an operating system, a resource, or by an object itself. A stream of metric data comprises a sequence of time-ordered metric values that are recorded in spaced points in time called “time stamps” and stored in a metrics database. A stream of metric data is simply called a “metric” and is denoted by

$${( {x}_{i} )}_{i = 1}^{N} = {( x ( {t}_{i} ) )}_{i = 1}^{N} \qquad ( 1 )$$

where
N is the number of metric values in a sequence of metric values;
xᵢ=x(tᵢ) is a metric value:
tᵢ is a time stamp indicating when the metric value was generated; and
subscript i is a time stamp index, i=1, . . . , N.

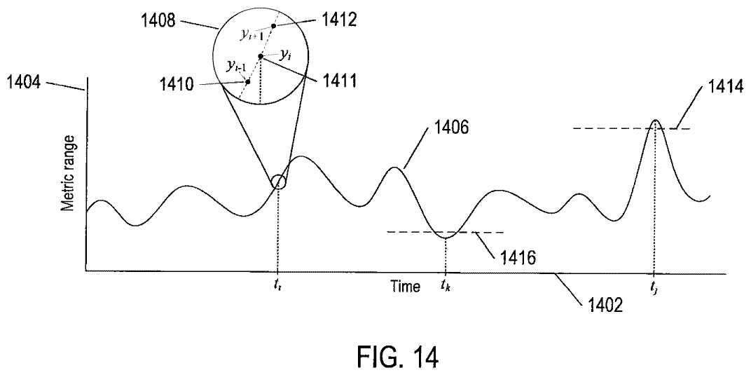

FIG. 14 shows a plot of an example metric. Horizontal axis 1402 represents time. Vertical axis 1404 represents a range of metric values. Curve 1406 represents a metric as time-series data. In practice, a metric comprises a sequence of discrete metric values in which each metric value is recorded in a data-storage device. FIG. 14 includes a magnified view 1408 of three consecutive metric values represented by points. Each point represents an amplitude of the metric at a corresponding time stamp. For example, points 1410-1412 represent consecutive metric values (i.e., amplitudes) xᵢ₋₁. xᵢ, and xᵢ₊₁ recorded in a data-storage device at corresponding time stamps tᵢ₋₁, tᵢ, and tᵢ₊₁.

Metrics are key performance indicators (“KPIs”) of how physical and virtual objects are performing in a cloud environment. A metric can represent CPU usage of a core in a multicore processor of a server computer over time. A metric can represent the amount of virtual memory a VM uses over time. A metric can represent network throughput for a server computer or a VM. Network throughput is the number of bits of data transmitted to and from a physical or virtual object and is recorded in megabits, kilobits, or bits per second. A metric can represent network traffic for a server computer or a VM. Network traffic at a physical or virtual object is a count of the number of data packets received and sent per unit of time. A metric may can represent object performance, such as CPU contention, response time to requests, and wait time for access to a resource of an object. Network flows are metrics that indicate a level of network traffic. Network flows include, but are not limited to, percentage of packets dropped, data transmission rate, data receiver rate, and total throughput.

The operations manager 1330 constructs KPIs from combinations of metrics and stores the KPIs in the metrics database. An application, for example, can have numerous associated KPIs. A distributed resource scheduling (“DRS”) score is an example of a KPI that is constructed from other metrics and is used to measure the performance level of a VM. container. or components of a distributed application. The DRS score is a measure of efficient use of resources (e.g., CPU, memory, and network) by an object and is computed as a product of efficiencies as follows:

$$x ( {t}_{i} ) = {EFFCY}_{CPU} ( {t}_{i} ) \times {EFFCY}_{Mem} ( {t}_{i} ) \times {EFFCY}_{Net} ( {t}_{i} ) \qquad ( 2 )$$

$$where$$

$${EFFCY}_{CPU} ( {t}_{i} ) = \frac{CPU usage ( {t}_{i} )}{Ideal CPU usage} :$$

$${EFFCY}_{Mem} ( {t}_{i} ) = \frac{Memory usage ( {t}_{i} )}{Ideal Memory usage} : and$$

$${EFFCY}_{Net} ( {t}_{i} ) = \frac{Network throughput ( {t}_{i} )}{Ideal Network throughput}$$

The metrics CPU usage(tᵢ). Memory usage(tᵢ). and Network throughput(tᵢ) of an object are measured at points in time as described above with reference to Equation (2). Ideal CPU usage, Ideal Memory usage. and Ideal Network throughput are preset. For example, Ideal CPU usage may be preset to 30% of the CPU and Ideal Memory usage may be preset to 40% of the memory. DRS scores can be used, for example, as a KPI that measures the overall health of a distributed application by aggregating, or averaging, the DRS scores of each VM that executes a component of the distributed application.

Other examples of KPIs include average response times to client request, error rates, contention time for resources, a peak response time, response times to API calls, amount of time to perform an operation. Other types of KPIs can be used to measure the performance level of an ecommerce application. For example, a KPI for an online shopping application could be the number of shopping carts successfully closed per unit time. A KPI for a website may be response times to customer requests. KPIs may also include latency in data transfer, throughput, number of packets dropped per unit time, or number of packets transmitted per unit time.

The operations manager 1330 uses thresholds to monitor KPIs for events. An event is detected when one or more metric values of a KPI violate an upper threshold 1414 denoted by:

$${x}_{j} \geq {Th}_{upper} \qquad ( 3 a )$$

where Thᵤₚₚₑᵣ is an upper threshold; and
   An event is detected when one or more metric values of a KPI violates a lower threshold 1416 denoted by:

$${x}_{j} \leq {Th}_{lower} \qquad ( 3 b )$$

where Th_{lower} is a lower threshold.
   In one implementation, the thresholds in Equations (3a) and (3b) are time-independent thresholds. Time-independent thresholds can be determined for trendy and non-trendy randomly distributed metrics. In another implementation, the thresholds may be time-dependent, or dynamic, thresholds. Dynamic thresholds can also be determined for trendy and non-trendy periodic metric data. Time-independent thresholds may be determined as described in US Publication No. 2015/0379110A1, filed Jun. 25, 2014, which is owned by VMware Inc. and is herein incorporated by reference. Dynamic thresholds may be determined as described in U.S. Pat. No. 10,241,887, which is owned by VMware Inc. and is herein incorporated by reference. The operations manager 1330 can detect certain problems from threshold violations (e.g., Eqs. (3a) or (3b)) described above. Other types of problems may not have an alert or threshold and are detected by a systems administrator or a product engineer.

The operations manager 1330 enables domain experts to monitor KPIs of objects that do not have associated alerts for a performance problem and generate rules for determining the underlying root cause of the problem. For the sake of illustration and discussion, methods and systems for generating rules of an object executing in a cloud infrastructure are described below with reference to a cloud proxy and components of the cloud proxy. However, the methods and systems are not limited to the object being a cloud proxy. The object and components of the object can be any monolithic application or distributed application executing in a cloud infrastructure.

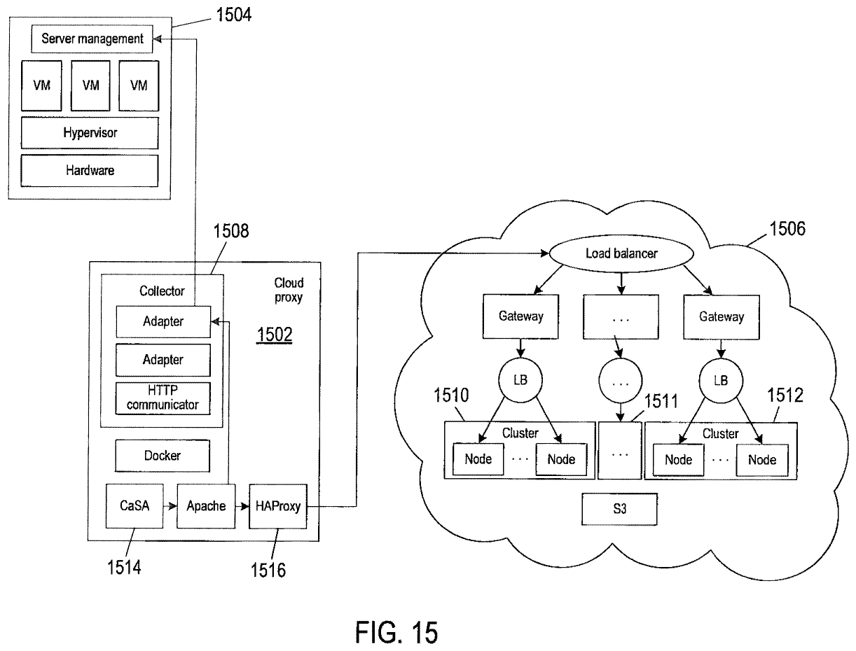

FIG. 15 shows an example of a problem detected with a cloud proxy for which an alert does not exist. In FIG. 15, a cloud proxy 1502 is located between a cluster of VMs 1504 and a cloud environment 1506. The cloud proxy 1502 connects the cluster 1504 to a web server, SaaS application, or other services performed in the cloud infrastructure 1506. The cloud proxy 1502 acts an intermediary between the cluster 1504 and the services of the cloud infrastructure, providing secure access to resources of the cloud infrastructure 1506 while protecting the cloud infrastructure from malware and other threats from systems located outside the cloud infrastructure. Requests that originate with the cluster 1504 flow through the cloud proxy 1502 to systems within the cloud infrastructure 1506 and replies, such as permission to access a webpage or a service executing the cloud infrastructure 1506. flow back through the cloud proxy 1502 to the cluster 1504.

The cloud proxy 1502 includes components, such as a collector 1508 that is responsible for data collection from the cluster 1504 and sending the data to clusters of nodes 1510-1512 in the cloud infrastructure 1506 and cluster and slice administration (“CaSA”) 1514 that is responsible for management of the cloud proxy 1502 and performs the operations of initial deployment, upgrade, configuration, and collection of metrics for self-monitoring. As shown in FIG. 15, communications from the cloud proxy 1502 to the node clusters 1510-1512 of the cloud infrastructure output from an HAproxy 1516 that provides a load balancer and reverse proxy for TCP and HTTP-based applications and spreads requests across the node clusters 1510-1512.

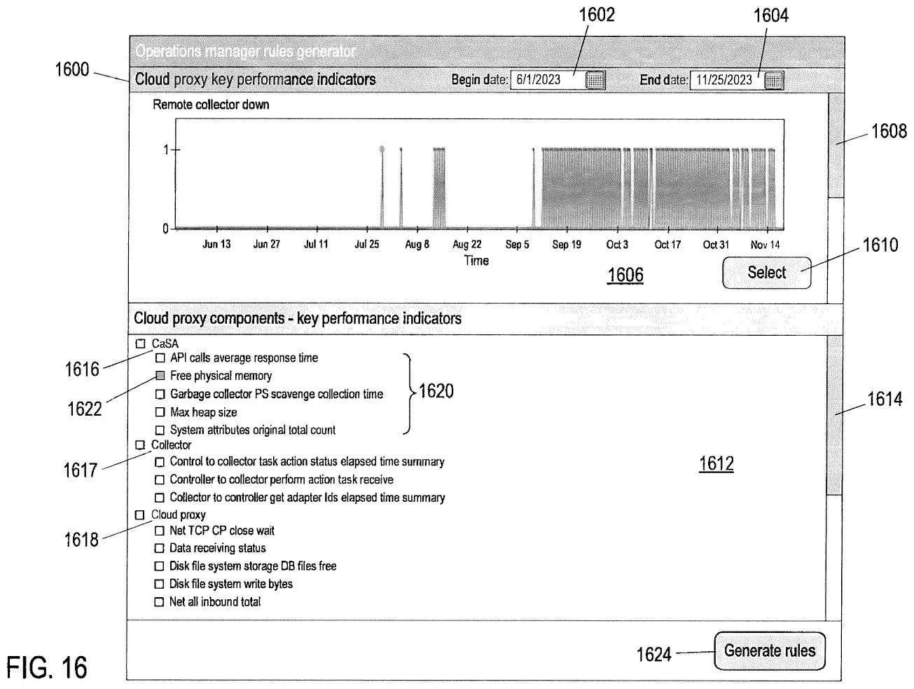

FIG. 16 shows an example graphical user interface (“GUI”) 1600 that enables a user, such as a domain expert, to view KPIs of the cloud proxy 1502 for potential problems. In this example, the GUI 1600 includes a field 1602 that enables a user to enter a begin date 1602 and an end date 1604 of a metric data collection interval for KPIs of the cloud proxy 1502. The GUI 1600 includes a pane 1606 for displaying the KPIs recorded over the time interval. The pane 1606 includes a scroll bar 1608 that enables the user to scroll up and down and view a plot of each of the KPIs over the time interval. In this example view, the metric data for the “Remote collector down” KPI is plotted in the pane 1606. The Remote collector down KPI is composed of binary values with “0” indicating a running or available status of the cloud proxy 1502 and “1” indicating a down or not available status of the cloud proxy 1502. The Remote collector down KPI shows that before September 5^{th} the cloud proxy 1502 is down at few instances. However, after September 5^{th}, the cloud proxy 1502 is down most of the time, which is an indication to a domain expert of a problem that started with the cloud proxy. However, an alert does not exist for the Remote collector down KPI because this KPI only reports available and unavailable status of the cloud proxy 1502 and occasional down episodes, such as those before September 5^{th}, do not necessarily mean that the cloud proxy 1502 is malfunctioning. KPIs of the cloud proxy 1502 are listed in pane 1606. Each KPI includes a select button, such as select button 1610, that enables the user to select a particular KPI of the proxy cloud 1502. In this example, the user has selected the Remote collector down KPI. The GUI 1600 includes a pane 1612 that lists components 1614-1616 of the cloud proxy 1502 and the names of the KPIs of each component. The pane 1610 includes a scroll bar 1612 that enables the user to view a complete list of the KPIs of the components of the cloud proxy 1502. For example, the CaSA component 1616 has five KPIs 1620. Based on the user's domain expertise, the user can select the component KPIs the user believes may be relevant in constructing rules for detecting the down status of the cloud proxy 1502 by clicking on the corresponding box. For example, the user selected the KPI “free physical memory” of the component CaSA 1616 by clicking on box 1622. When a user clicks on the “generate rules” button 1624, the operations manager 1330 retrieves the metric data of the user selected component KPIs over the time interval from the metric database to generate rules for detecting the available and not available status of the cloud proxy 1502.

Each of the KPIs selected in the GUI 1600 is time synchronized to the same time index over the same user selected time interval by the operations manager 1330. Time synchronization is performed by partitioning the user selected time interval into equal duration subintervals. Min-max smoothing is performed in each subinterval. For each subinterval, the minimum and maximum metric values are located. The earlier of the minimum and maximum metric values is moved and aligned with a time index that corresponds to the midpoint of the subinterval and the later in time of the minimum and maximum metric values is moved and aligned with a time index that correspond to the end of the subinterval. The non-minimum and non-maximum metric values are deleted from the subinterval. This process is repeated for each of the subintervals of the user selected time interval, leaving a reduced number of regularly spaced minimum and maximum metric values of the KPI.

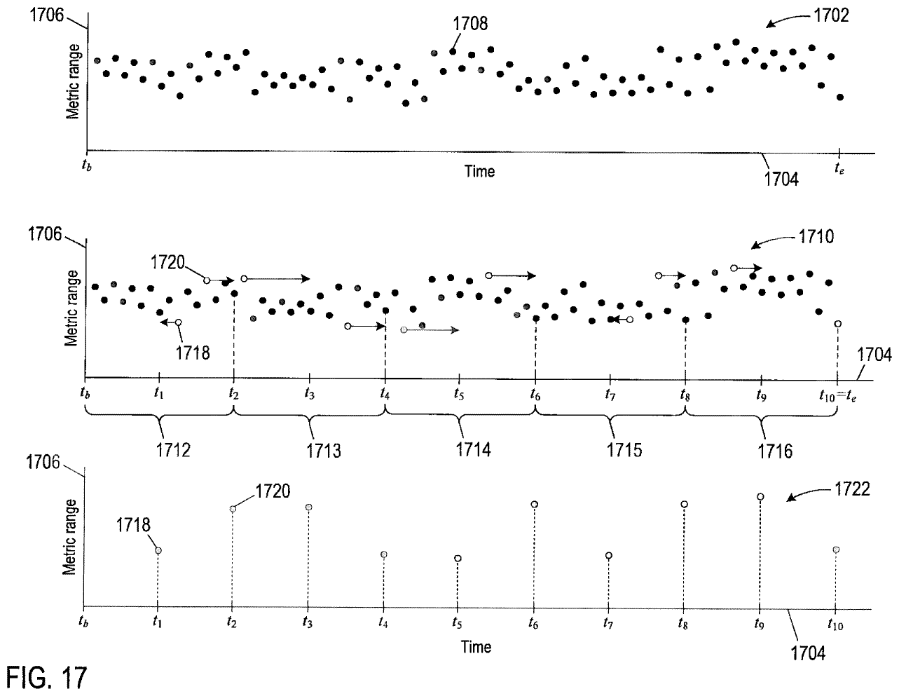

FIG. 17 shows an example of time synchronizing the metric values of a KPI over a user selected time interval. In plot 1702, horizontal axis 1704 represents time. Vertical axis 1706 represents a range of the KPI. Points, such as point 1708, represent metric values of the KPI over a user selected time interval [t_{b}, tₑ], where t_{b} denotes the beginning of the time interval and tₑ denotes the end of the time interval. In plot 1710, the time interval [t_{b}, tₑ] is partitioned into five subintervals 1712-1716. The midpoints and end points of the subintervals are time indexed, tₖ, where k=1, 2, . . . , 10. In each subinterval, two gray shaded points represent the minimum and maximum metric values of the KPI of the subinterval. Directional arrows represent moving the earlier of the minimum and maximum metric values in the same subinterval to the midpoint of the subinterval and moving the later in time of the minimum and maximum metric values to the end of the subinterval. For example, in the subinterval 1712, the minimum metric value 1718 occurs earlier in time than the maximum metric value 1720. As a result, the minimum metric value 1718 is moved and aligned with time index t₁ at the midpoint of the subinterval 1712 and the maximum metric value 1720 is moved and aligned with time index t₂ at the end of the subinterval 1712. The remaining metric values in the subinterval 1712 are deleted. The process of identifying the minimum and maximum metric values, moving the minimum and maximum metric values to the midpoint and the end point of the subinterval, and deleting metric values other than the minimum and maximum metric values is repeated separately for each of the remaining subintervals 1713-1716, leaving regularly spaced metric values of subintervals of the KPI in plot 1722.

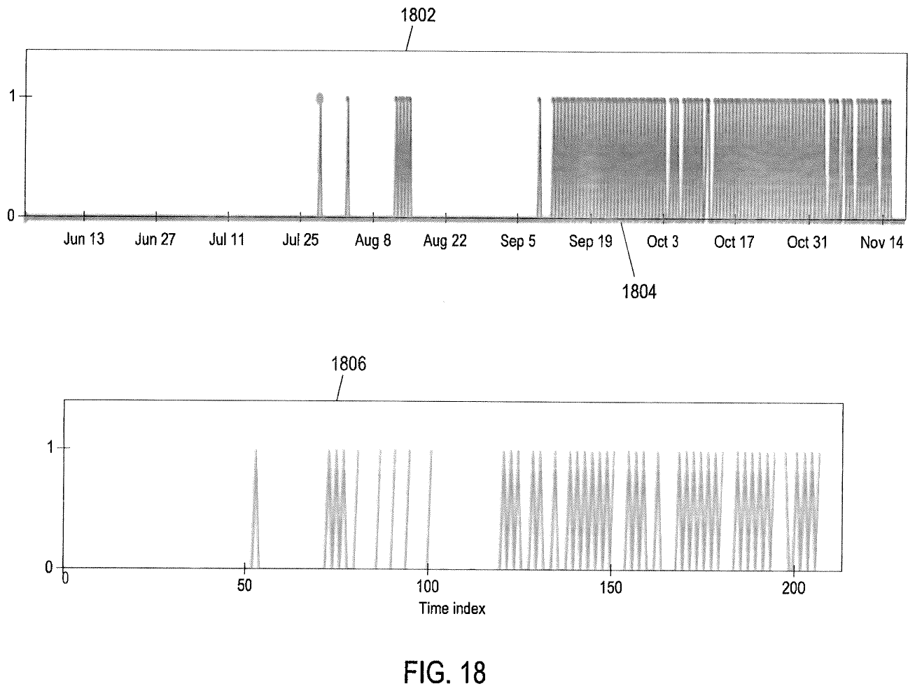

Min-max smoothing is applied to the object KPI. FIG. 18 shows an example of how min-max smoothing reduces the number of metric values of the Remote collector down KPI. Plot 1802 shows the Remote collector down KPI of the cloud proxy 1502 collected over a nearly six-month time interval 1804 as described above with reference to FIG. 16. The remote collector down KPI has 7530 metric values. Plot 1804 shows smooth remote collector down KPI after applying min-max smoothing as described above. Partitioning the nearly six-month time interval 1804 into six-hour subintervals and applying min-max smoothing in each subinterval as described above reduces the number of metric values from 7530 in the plot 1802 to 208 metric values in the plot 1806.

Let R be the number of user selected component KPIs of the object. For example, in FIG. 16, R equals five if the user selected the five component KPIs “API calls average response time,” “Free physical memory,” “Garbage collector PS scavenge collection time,” “Max heap size,” and “System attributes original total count” of the CaSA component of the cloud proxy 1502 in the GUI 1606. The sequence of metric values in a smooth component KPI are denoted by

$${v}_{r} = {( {x}_{rk} )}_{k = 1}^{M} \qquad ( 4 )$$

where
r=1, . . . , R and R is the number of user selected KPIs of a component of the object; and
M is the number of metric values after min-max smoothing.

The operations manager 1330 may normalize the metric values of the smooth KPIs. The normalized metric values are given by

$${x}_{rk} = \frac{{x}_{rk} - {x}_{k}^{min}}{{x}_{k}^{max} - {x}_{k}^{min}}$$

where
xₖ^{max} is the maximum metric value in vₖ; and
xₖ^{min} is the minimum metric value in vₖ.

Metric values of the smooth component KPIs have the same corresponding time indices and form an R-tuple at each time index tₖ denoted by (x₁ₖ, x₂ₖ, x₃ₖ, . . . , x_{Rk}). The metric values of the object KPI are used to apply a class label the R-tuples denoted by (x₁ₖ, x₂ₖ, x₃ₖ, . . . , x_{Rk}; class label), where the class label equals “1” or “0.” For example, the metric values of the smooth Remote controller down KPI can be “1,” which corresponds to the cloud proxy 1502 being down, or “0,” which corresponds to the cloud proxy 1502 being up and running. Class labels of the smooth object KPIs can also be determined based on metric values of a smooth object KPI that violate a corresponding threshold. For example, a smooth metric value xₖ that violates a corresponding threshold as described above with reference to Equations (3a) and (3b) is assigned a class label “1” and is assigned a class label “0” if the smooth metric value xx does not violate a corresponding threshold.

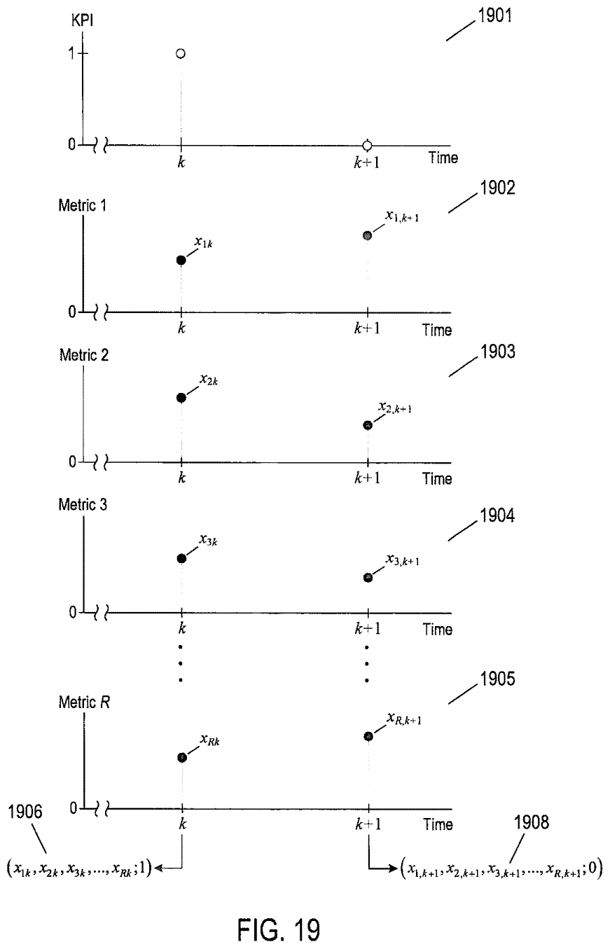

FIG. 19 shows an example of forming class labeled R-tuples from R smooth component KPIs and class labels of a smooth object KPI at the same time indices. Plot 1901 shows two class labels of an object KPI with class label “1” occurring at time index k and class label “0” occurring at time index k+1. Plots 1902-1905 show metric values of four of the R smooth component KPIs at the time index k and time index k+1. The metric values and corresponding class label at time index k form class labeled R-tuple 1906. The metric values and corresponding class label at time index k+1 form class labeled R-tuple 1908.

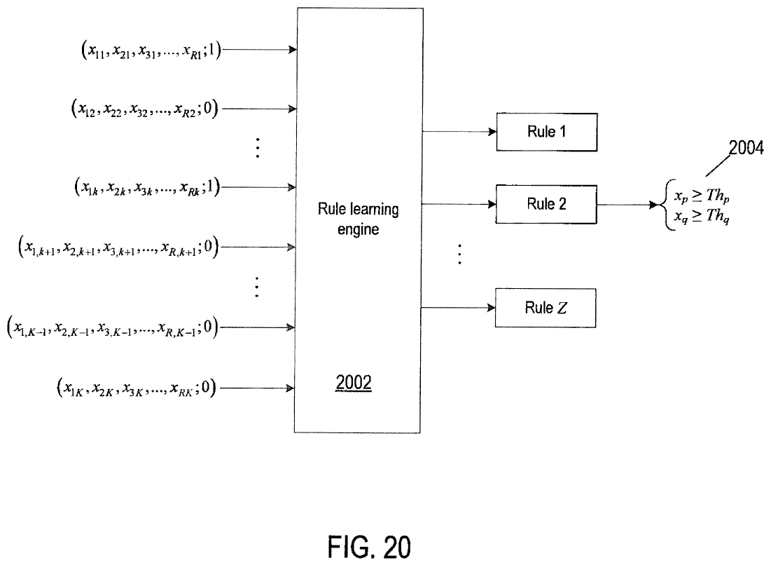

FIG. 20 shows an example rule learning engine used to generate rules for detecting a performance problem with an object of a cloud infrastructure. Block 2002 represents a rule learning engine that receives as input class-labeled R-tuples for a component of the object. The rule learning engine 2002 is a class-based rule induction algorithm that is trained using the class-labeled R-tuples. The rule learning engine 2002 can be a well-known decision tree, random forest, C5.0 classification model, or the repeated incremental pruning to produce error protection classification algorithm (“RIPPER”). The rule learning engine 2002 generates Z rules denoted by Rule z, where z=1, . . . , Z, for detecting state of the object based on the KPIs of a component of the object. Each rule is composed of one or more conditional statements associated with one of the classes. A conditional statement relates a metric value of a KPI to a threshold, such as xᵣ≥Thᵣ or xᵣ≤Thᵣ, where Thᵣ denotes the threshold for the KPI of the r-th component of the object. For example, Rule 2 is composed of two conditions 2004 for detecting a problem (i.e., class=1) with the object. When the metric value xₚ of the KPI of the p-th component satisfies the conditional statement xₚ≥Thₚ and the metric value x_{q} of the KPI of the q-th component satisfies the condition statement x_{q}≥Th_{q}, the object is exhibiting a performance problem.

Note that a rule learning engine is used to construct rules from the KPIs of each component of the object. In other words, a different set of rules is learned from the user selected KPIs of each component of the object.

After a set of rules is generated for each component of the object, the rules are validated by domain experts using a graphical user interface (“GUI”). The operations manager 1330 displays the rules and corresponding conditional statements output from the rules learning engine for each component in a GUI that enables domain experts to validate each conditional statement of each rule. The GUI enables a domain expert to attach a recommendation for resolving the problem and enrich the rules by removing certain conditional statements and/or adding other conditional statements that were not output from the rule learning engine based on the domain expert's knowledge and experience.

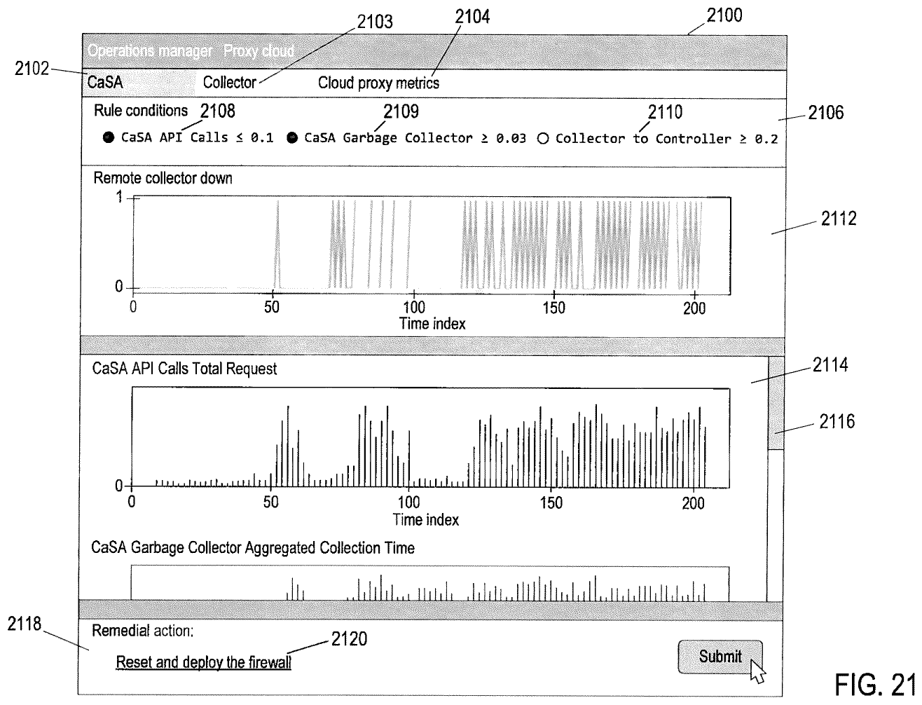

FIG. 21 shows an example GUI 2100 displayed by the operations manager 1330 in a display device in response to the user selecting generate rules 1624 for the cloud proxy 1502 from selected KPIs of the components CaSA, Collector, and Cloud proxy. The GUI 2100 includes tabs 2102-2104 for each of the components CaSA, Collector, and Cloud proxy. In this example, the user selects the CaSA tab 2102 which displays the conditional statements 2108-2110 output from the rules learning engine in pain 2106. Each conditional statement includes a button for selecting the conditional statements that form the rule. The GUI 2100 includes a pane 2112 that displays the smooth remote collected down KPI. The GUI 2100 includes a pane 2114 that displays the smooth CaSA component KPIs selected by the user in the GUI 1600. The pane 2114 includes a scroll bar 2116 that enables the user to view a plot of each of the smooth CaSA component KPIs selected by the user. The GUI 2100 includes a pain 2118 that enables the user to input a recommendation link 2120 to a script that executes remedial measures to correct the problem. In this example, the user selects conditional statements 2108 and 2109 and does not select conditional statement 2110. As a result, the rule for the CaSA component to determine a problem with the cloud proxy 1502 based on performance of the CaSA component is composed of the conditional statements 2108 and 2109. The CaSA rule with conditional statements 2108 and 2109 is stored in a knowledge store in response to the user clicking on the submit button 2124. The same process of verifying and storing conditional statements of rules associated with the other components, Collector 2103 and Cloud proxy metrics 2104. is repeated by the user.

The rules for the components CaSA, Collector, and Cloud proxy metrics and associated recommendations for correcting the problem are stored in a knowledge store and used in combination to detect a performance problem with the cloud proxy. Example rules stored in the knowledge base for detecting the cloud proxy 1502 in a down state are given as follows:

### Casa Rule:

CaSA API Calls Total Requests≤0.1

CaSA Garbage Collector Aggregated Collection Time≥0.03

### Collector Rule:

Collector to Control Lookup Resource Elapsed Time≥0.002

### Cloud Proxy Rule:

Net TCP Listen=0.0

The rules and the specific behavior of the corresponding KPI's are stored in a knowledge base that is used for identification and fast resolution of similar issues. When a run time metric values satisfy the conditional statements of the CaSA rule, the collector rule, and the cloud proxy rule, an alert is triggered and displayed in a GUI. The recommendation for correcting the problem is also displayed.

Method and systems described above can be used to generate rules for objects executing a cloud infrastructure. The conditional statements of each rule are evaluated by domain experts and include corresponding recommended remedial measures for correcting the problems detected with the rules. Remedial measures include migrating a component of the object to a server computer with more resources than the server computer the object is running on. Remedial measures also include increasing allocation of resources, such as CPU, memory, disk space, and network bandwidth, to the object.

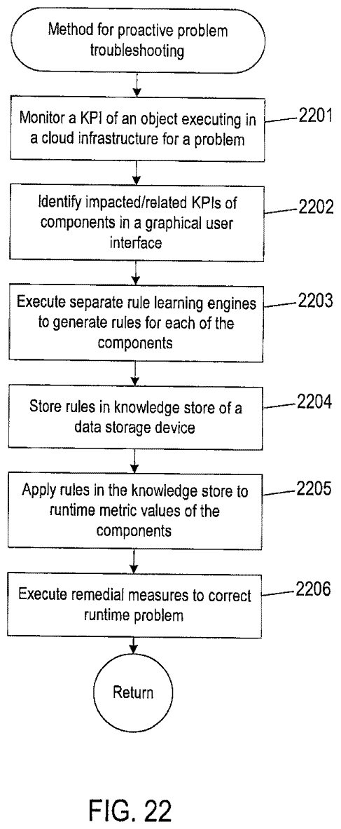

FIG. 22 is a flow diagram of a method for proactive troubleshooting and correcting of a problem with an object in a cloud infrastructure. In block 2201, monitor a KPI of the object for a problem as described above with reference to FIG. 16. In block 2202, identify impacted/related KPIs of components of the object via a GUI as described above with reference to FIG. 16. In block 2203, for each of the components of the object, execute a separate rule learning engine to generate rules for detecting a problem with the component based on the KPI of the object and the KPIs of the component. In block 2204, the rules generated in block 2203 are stored in a knowledge base of a data storage device. In block 2205, apply the rule in the knowledge base to detect a runtime problem with object. In block 2206, execute at least one of the remedial measures to resolve the problem with the object via the GUI.

The process described above with reference to FIG. 22 is stored in one or more data-storage devices as machine-readable instructions and executed by one or more processors of a computer system, such as the computer system shown in FIG. 1.

The computer-implemented methods described above have the advantage of eliminating human errors in creating rules for detecting problems with running in a cloud infrastructure. The computer-implemented methods also significantly reduce the time for detecting and correcting problems with objects from days and weeks to minutes and seconds.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A computer-implemented process for troubleshooting and resolving problems with objects of a cloud infrastructure, the process comprising:
monitoring a key performance indicator (“KPI”) of an object running in the cloud infrastructure for abnormal behavior of the object;
displaying a graphical user interface (“GUI”) in a display device that enables a user to select KPIs of components of the object for generating rules to detect the problem;
for each of the components, executing a separate rule learning engine that generates rules for detecting a problem with the component based on the KPI of the object and the KPIs of the component;
using the rules to detect a runtime problem with the object and display at least one remedial measure for resolving the problem in the GUI based on runtime metric values of the KPIs of the components; and
executing at least one of the remedial measures to resolve the problem with the object via the GUI.

2. The process of claim 1 wherein monitoring the KPI of the object comprises:
displaying the KPI of the object in a user selected time interval in the GUI; and
selecting the KPI for rule generating the rules via the GUI.

3. The process of claim 1 wherein executing the separate rule learning engine that generates rules for detecting the problem with the component comprises:
applying min-max smoothing to time synchronize the KPI of the object and each of the KPIs of the component to the same time indices;
for each time index, forming a class-based tuple of metric values of the KPIs and a class label of the KPI of the object; and
using rule induction to generate the rules based on the class-based tuples.

4. The process of claim 1 wherein executing the separate rule learning engine that generates rules for detecting the problem with the component comprises storing the rules for each component in a knowledge base of a data storage device.

5. A computer system for troubleshooting and resolving problems with objects of a cloud infrastructure, the computer system comprising:
a display screen;
one or more processors;
one or more data-storage devices; and
machine-readable instructions stored in the one or more data-storage devices that when executed using the one or more processors control the system to perform operations comprising:
monitoring a key performance indicator (“KPI”) of an object running in the cloud infrastructure for abnormal behavior of the object;
displaying a graphical user interface (“GUI”) in a display device that enables a user to select KPIs of components of the object for generating rules to detect the problem;
for each of the components, executing a separate rule learning engine that generates rules for detecting a problem with the component based on the KPI of the object and the KPIs of the component;
using the rules to detect a runtime problem with the object and display at least one remedial measure for resolving the problem in the GUI based on runtime metric values of the KPIs of the components; and
executing at least one of the remedial measures to resolve the problem with the object via the GUI.

6. The system of claim 5 wherein monitoring the KPI of the object comprises:
displaying the KPI of the object in a user selected time interval in the GUI; and
selecting the KPI for rule generating the rules via the GUI.

7. The system of claim 5 wherein executing the separate rule learning engine that generates rules for detecting the problem with the component comprises:
applying min-max smoothing to time synchronize the KPI of the object and each of the KPIs of the component to the same time indices;
for each time index, forming a class-based tuple of metric values of the KPIs and a class label of the KPI of the object; and
using rule induction to generate the rules based on the class-based tuples.

8. The system of claim 5 wherein executing the separate rule learning engine that generates rules for detecting the problem with the component comprises storing the rules for each component in a knowledge base of a data storage device.

9. A non-transitory computer-readable medium having instructions encoded thereon for enabling one or more processors of a computer system to perform operations comprising:
monitoring a key performance indicator (“KPI”) of an object running in the cloud infrastructure for abnormal behavior of the object;
displaying a graphical user interface (“GUI”) in a display device that enables a user to select KPIs of components of the object for generating rules to detect the problem;
for each of the components, executing a separate rule learning engine that generates rules for detecting a problem with the component based on the KPI of the object and the KPIs of the component;
using the rules to detect a runtime problem with the object and display at least one remedial measure for resolving the problem in the GUI based on runtime metric values of the KPIs of the components; and
executing at least one of the remedial measures to resolve the problem with the object via the GUI.

10. The medium of claim 9 wherein monitoring the KPI of the object comprises:
displaying the KPI of the object in a user selected time interval in the GUI; and
selecting the KPI for rule generating the rules via the GUI.

11. The medium of claim 9 wherein executing the separate rule learning engine that generates rules for detecting the problem with the component comprises:
applying min-max smoothing to time synchronize the KPI of the object and each of the KPIs of the component to the same time indices;
for each time index, forming a class-based tuple of metric values of the KPIs and a class label of the KPI of the object; and
using rule induction to generate the rules based on the class-based tuples.

12. The medium of claim 9 wherein executing the separate rule learning engine that generates rules for detecting the problem with the component comprises storing the rules for each component in a knowledge base of a data storage device.
